(19) United States
(12) Patent Application Publication
(10) Pub. No.: US 2016/0070146 A1
(43) Pub. Date: Mar. 10, 2016

(54) COLOR FILM SUBSTRATE AND LIQUID CRYSTAL DISPLAY DEVICE

(71) Applicants: BOE TECHNOLOGY GROUP CO., LTD., Beijing (CN); HEFEI BOE OPTOELECTRONICS TECHNOLOGY CO., LTD., Hefei (CN)

(72) Inventor: SHIQIANG HUANG, Beijing (CN)

(21) Appl. No.: 14/801,779

(22) Filed: Jul. 16, 2015

(30) Foreign Application Priority Data
Sep. 9, 2014 (CN) 201410456252.5

(51) Int. Cl. G02F 1/1362; G02F 1/1335

(52) U.S. Cl. CPC G02F 1/136204; G02F 1/133514

(57) ABSTRACT

The present invention discloses a color film substrate and a liquid crystal display device. The color film substrate comprises a base substrate, a photoresist layer and an anti-static layer, wherein the anti-static layer and the photoresist layer are arranged on the same side of the base substrate. The liquid crystal display device comprises an array substrate, the above color film substrate and a sealant, wherein conducting particles are arranged in the sealant to electrically connect the anti-static layer with a zero-potential line of the array substrate. With the arrangement of the anti-static layer and the sealant with the conducting particles in this disclosure, reliable electric connection between the anti-static layer and the zero-potential line of the array substrate can be guaranteed; the occurrence of a poor contact phenomenon caused by the absence of coating or poor coating quality of the conductive silver paste in the prior art is avoided, thereby the interference of external static electricity on an internal electric field of a liquid crystal panel can be effectively prevented, the anti-static capability of the liquid crystal display device is improved, and the quality of the whole liquid crystal display device can be guaranteed.

### RELATED APPLICATIONS

The present application claims the benefit of Chinese Patent Application No. 201410456252.5, filed on Sep. 9, 2014, the entire disclosure of which is incorporated herein by reference.

### FIELD

The present disclosure relates to the technical field of liquid crystal display, and particularly relates to a color film substrate and a liquid crystal display device.

### BACKGROUND

A liquid crystal display device such as an ADS (Advanced super Dimension Switch) liquid crystal display device generally comprises a color film substrate, an array substrate, a liquid crystal layer, a sealant and a printed circuit board, wherein a black matrix and a photoresist are arranged on the color film substrate, a TFT (Thin-Film Transistor) is arranged on the array substrate, and a spacer is arranged in the liquid crystal layer.

In the manufacturing and using processes of a liquid crystal display device, static electricity accumulated on the color film substrate is created. A static electric field can be generated after the static electricity is accumulated to a certain degree. The static electric field may disturb the electric field of liquid crystal molecules inside a liquid crystal panel, and as a result, cause abnormal display pictures. Therefore, the shielding or elimination of the external static electricity is very important for the liquid crystal display device.

The influence of the external static electricity on the liquid crystal display device is eliminated in the prior art mainly in the following ways: (1) reducing or isolating the source of the static electricity, this method cannot eliminate the problem of static electricity accumulation completely; (2) designing a circuit to discharge the static electricity in time, in order to eliminate the static electricity completely. For example, as shown in FIG. 1, an anti-static layer 10 is arranged on the outer surface of the color film substrate, the anti-static layer is connected with a grounded terminal on the array substrate through the coating of conductive silver paste, and thus the effect of preventing the static electricity is enabled.

In the prior art, the conductive silver paste is coated on the pad area of the liquid crystal display device so that the anti-static layer 10 is connected with the zero potential of the TFT on the array substrate; when the conductive silver paste is in poor coating condition or is disconnected, the anti-static layer 10 is in poor contact with a grounded line of the array substrate, and thus the static electricity on the color film substrate cannot be discharged completely and in time. The static electric field caused by the static electricity leads to harmful effect on a liquid crystal electric field in the device, so that the arrangement of liquid crystal molecules is influenced, and in turn the light leakage of pixels is caused. Since human eyes are most sensitive to green light, the problem that greenish black image appears on the liquid crystal display device may be raised to cause quality reduction of image display.

### SUMMARY

Embodiments of the present disclosure provide a color film substrate and a liquid crystal display device, which can at least mitigate or eliminate the problems mentioned above.

According to the first aspect of the present disclosure, a color film substrate is provided, comprising a base substrate, a photoresist layer arranged on the base substrate and a transparent and conducting anti-static layer, the anti-static layer and the photoresist layer being arranged on the same side of the base substrate.

According to an embodiment of the disclosure, the anti-static layer may be arranged between the base substrate and the photoresist layer; or, the anti-static layer may be arranged on a side, facing away from the base substrate, of the photoresist layer.

According to another embodiment of the disclosure, the anti-static layer may be one selected from a group comprising an indium tin oxide thin film, an indium zinc oxide thin film and an indium gallium zinc oxide thin film or a stack of at least two selected from the said group.

According to the second aspect of the present disclosure, a liquid crystal display device is provided, comprising an array substrate on which a zero-potential line is arranged, the color film substrate according to the first aspect of the disclosure, a sealant for adhering the color film substrate with the array substrate, wherein the sealant being arranged in an edge area of the anti-static layer on the color film substrate, and conducting particles being arranged in the sealant to electrically connect the anti-static layer with the zero-potential line of the array substrate.

According to an embodiment of the disclosure, the edge area of the anti-static layer may be exposed outside of an edge of the photoresist layer. The exposed part of the edge area of the anti-static layer can realize good contact with a sealant containing conducting particles conveniently, enabling reliable electric connection between the anti-static layer and a zero-potential line of the array substrate.

According to another embodiment of the disclosure, the conducting particles may be hollow balls, and a metal conducting layer is coated on the outer surface of each hollow ball; or, the conducting particles are solid metal balls.

According to yet another embodiment of the disclosure, the particle sizes of the conducting particles are not less than the distance between the color film substrate and the array substrate.

According to still another embodiment of the disclosure, one end of the conducting particles is electrically connected with the anti-static layer, and another end of the conducting particles is electrically connected with the zero-potential line of the array substrate.

According to an embodiment of the disclosure, at least two vertically arranged conducting particles capable of forming a conductive path are arranged in the sealant along the vertical direction of the sealant, and the vertically arranged conducting particles can be used for connecting the anti-static layer with the zero-potential line of the array substrate.

According to another embodiment of the disclosure, the zero-potential line of the array substrate may be grounded, or the zero-potential line of the array substrate may be connected with a zero-potential line of a circuit outside the array substrate.

According to yet another embodiment of the disclosure, the to zero-potential line of the array substrate may be arranged in the corner area of the liquid crystal display device.

The color film substrate provided by the first aspect of the present disclosure comprises a base substrate, a photoresist layer and an anti-static layer. Arranging the anti-static layer and the photoresist layer on the same side of the base substrate facilitates the good contact between the anti-static layer and the sealant containing the conducting particles, so that reliable electric connection between the anti-static layer and the zero-potential line of the array substrate is achieved. The liquid crystal display device provided by the second aspect of the present disclosure comprises an array substrate, a color film substrate according to the first aspect of the disclosure and a sealant, a zero-potential line being arranged on the array substrate, conducting particles being arranged in the sealant, and the sealant being arranged in the edge area of the anti-static layer on the color film substrate, so that the sealant not only play a role in adhering the color film substrate with the array substrate, but also electrically connect the anti-static layer to the zero-potential line of the array substrate, namely the anti-static layer is directly connected with the zero-potential line. There is no need for coating conductive silver paste on the pad areas of the liquid crystal display device. As a result, the occurrence of a poor contact phenomenon caused by absence of coating or poor coating quality of the conductive silver paste in the prior art is avoided, and the external static electricity can be shielded or eliminated in time, improving the anti-static capability of the liquid crystal display device. Thus, the quality of the whole liquid crystal display device can be guaranteed.

### BRIEF DESCRIPTION OF THE DRAWINGS

FIG. 1 is a schematic cross-section of a liquid crystal display device in the prior art;

FIG. 2 is a schematic cross-section of a liquid crystal display device provided by the embodiment of the present disclosure.

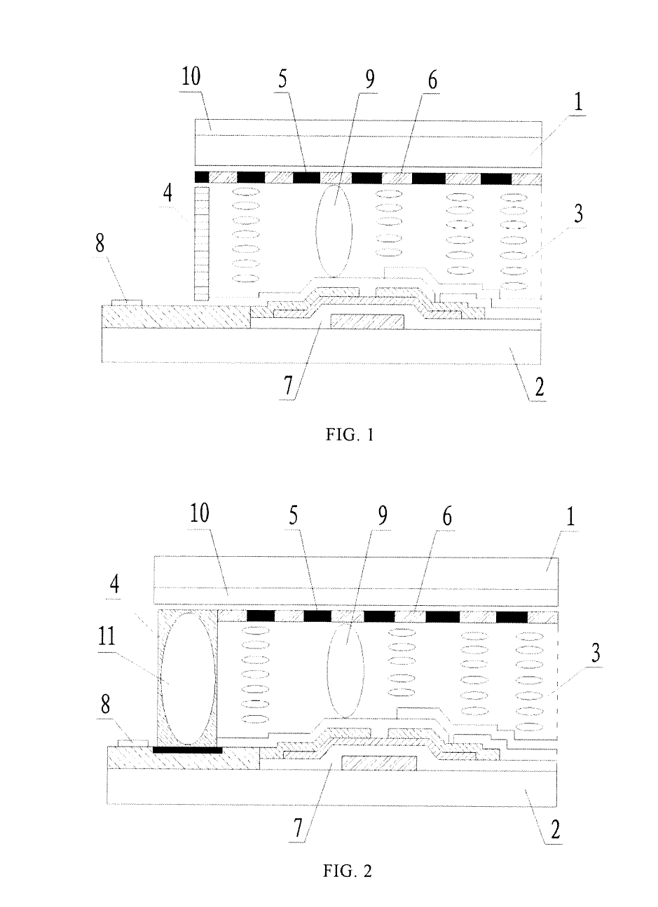

Wherein the reference numerals are:

1 base substrate, 2 array substrate, 3 liquid crystal layer, 4 sealant, 5 black matrix, 6 photoresist layer, 7 thin film transistor, 8 circuit board, 9 spacer, 10 anti-static layer, 11 solid metal ball.

### DETAILED DESCRIPTION

The detailed description of the embodiment of the present disclosure is further described in conjunction with the accompanying diagrams below.

As shown in FIG. 2, a color film substrate comprises a base substrate 1, a photoresist layer 6 and an anti-static layer 10, wherein the photoresist layer 6 and the anti-static layer 10 are arranged on the same side of the base substrate 1, the anti-static layer 10 is a transparent thin film, and particularly, an edge area of the anti-static layer is exposed outside the edge of the photoresist layer 6. The exposed part of the edge area of the anti-static layer 10 can realize good contact with a sealant containing conducting particles conveniently, enabling reliable electric connection between the anti-static layer 10 and a zero-potential line of the array substrate 2.

The anti-static layer 10 in the embodiment is arranged between the base substrate 1 and the photoresist layer 6. Of course, the anti-static layer 10 can also be arranged on a side, facing away from the base substrate, of the photoresist layer, namely the photoresist layer 6 is arranged between the base substrate 1 and the anti-static layer 10.

An indium tin oxide thin film (ITO film) is selected as the anti-static layer 10 in the embodiment. Of course, the anti-static layer 10 can also be anyone of an indium zinc oxide thin film and an indium gallium zinc oxide thin film capable of implementing the corresponding function of the present disclosure, or a stack of any two of the three thin films, or a stack of a combination of the three thin films.

FIG. 2 also shows a liquid crystal display device, comprising an array substrate 2, a sealant 4 and the color film substrate mentioned above. The zero-potential line is arranged on the array substrate 2, conducting particles are arranged in the sealant 4, and the sealant 4 is not only used for adhering the color film substrate with the array substrate 2 together, but also used for electrically connecting the anti-static layer 10 on the color film substrate with the zero-potential line of the array substrate 2 with the conducting particles inside. Thus, there is no need for coating a conductive silver paste on the side wall of the liquid crystal display device, so that the occurrence of a poor contact phenomenon caused by absence of coating or poor coating quality of the conductive silver paste in the prior art is avoided. As a result, static electricity deposited on the color film substrate can be discharged in time, so as to enhance the anti-static capability of the liquid crystal display device, guarantee the quality of the whole liquid crystal display device, and extent the lifetime of the liquid crystal display device.

The conducting particles in the embodiment are solid metal balls 11, the diameters of which are greater than the distance between the color film substrate and the array substrate 2 (namely cell thickness). That is, only one solid metal ball 11 is arranged in the sealant 4 along the vertical direction of the sealant 4, and the solid metal ball 11 is arranged in the sealant and between the color film substrate and the array substrate 2; when the two substrates are pressed and mounted together, the solid metal balls 11 are slightly deformed under the pressure of the two substrates, so that one end of the solid metal ball ills tightly in electric connection with the anti-static layer 10, and the other end of the solid metal ball 11 are tightly connected with the zero-potential line of the array substrate 2. In other words, the solid metal ball 11 is used for guaranteeing gapless contact between the anti-static layer 10 on the color film substrate and the zero-potential line on the array substrate 2 and consequently the occurrence of a poor electric contact phenomenon is avoided, and the conducting reliability of the solid metal ball 11 is guaranteed. Of course, besides the solid metal ball 11, the conducting particles can also be hollow balls and the like coated with metal conducting layers on the outer surfaces.

It is noted that at least two vertically arranged conducting particles capable of forming a conductive path may also be arranged in the sealant 4 along the vertical direction of the sealant, and the vertically arranged conducting particles can be used for connecting the anti-static layer 10 with the zero-potential line of the array substrate 2.

Moreover, the zero-potential line of the array substrate 2 in the embodiment can realize zero potential by grounding, or by being connected with a zero-potential line of a circuit outside the array substrate 2.

Sharp areas, such as corner areas, of the liquid crystal display device is an easy-to-discharge area of static electricity, and thus according to some examples, the zero-potential line is arranged at the corner area of the liquid crystal display device, so that external static electricity is released more easily, and the influence on the liquid crystal display device caused by the static electricity is largely reduced.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall fall within the protection scope of the present invention. Therefore, the scope of the present disclosure shall be defined by the claims.

1. A color film substrate, comprising a base substrate and a photoresist layer arranged on the base substrate, wherein the color film substrate further comprises a transparent and conducting anti-static layer, and the anti-static layer and the photoresist layer are arranged on the same side of the base substrate.

2. The color film substrate according to claim 1, wherein the anti-static layer is arranged between the base substrate and the photoresist layer; or, the anti-static layer is arranged on a side facing away from the base substrate of the photoresist layer.

3. The color film substrate according to claim 1, wherein the anti-static layer is one selected from a group comprising an indium tin oxide thin film, an indium zinc oxide thin film and an indium gallium zinc oxide thin film, or a stack of at least two selected from the said group.

4. A liquid crystal display device, comprising an array substrate on which a zero-potential line is arranged, wherein the liquid crystal display device further comprises:
the color film substrate of claim 1; and
a sealant for adhering the color film substrate with the array substrate, wherein the sealant is arranged in an edge area of the anti-static layer on the color film substrate, and conducting particles are arranged in the sealant to electrically connect the anti-static layer with the zero-potential line of the array substrate.

5. The liquid crystal display device according to claim 4, wherein the edge area of the anti-static layer is exposed outside of an edge of the photoresist layer.

6. The liquid crystal display device according to claim 4, wherein the conducting particles are hollow balls, and a metal conducting layer is coated on the outer surface of the hollow balls; or, the conducting particles are solid metal balls.

7. The liquid crystal display device according to claim 6, wherein the particle sizes of the conducting particles are not less than the distance between the color film substrate and the array substrate.

8. The liquid crystal display device according to claim 7, wherein one end of the conducting particles is electrically connected with the anti-static layer, and another end of the conducting particles is electrically connected with the zero-potential line of the array substrate.

9. The liquid crystal display device according to claim 6, wherein at least two vertically arranged conducting particles capable of forming a conductive path are arranged in the sealant along the vertical direction of the sealant, and the vertically arranged conducting particles are used for connecting the anti-static layer with the zero-potential line of the array substrate.

10. The liquid crystal display device according to claim 4, wherein the zero-potential line of the array substrate is grounded, or the zero-potential line of the array substrate is connected with a zero-potential line of a circuit outside the array substrate.

11. The liquid crystal display device according to claim 10, wherein the zero-potential line of the array substrate is arranged in the corner area of the liquid crystal display device.

12. The liquid crystal display device according to claim 5, wherein the zero-potential line of the array substrate is grounded, or the zero-potential line of the array substrate is connected with a zero-potential line of a circuit outside the array substrate.

13. The liquid crystal display device according to claim 12, wherein the zero-potential line of the array substrate is arranged in the corner area of the liquid crystal display device.

14. The liquid crystal display device according to claim 6, wherein the zero-potential line of the array substrate is grounded, or the zero-potential line of the array substrate is connected with a zero-potential line of a circuit outside the array substrate.

15. The liquid crystal display device according to claim 14, wherein the zero-potential line of the array substrate is arranged in the corner area of the liquid crystal display device.

16. The liquid crystal display device according to claim 7, wherein the zero-potential line of the array substrate is grounded, or the zero-potential line of the array substrate is connected with a zero-potential s line of a circuit outside the array substrate.

17. The liquid crystal display device according to claim 16, wherein the zero-potential line of the array substrate is arranged in the corner area of the liquid crystal display device.

18. The liquid crystal display device according to claim 8, wherein the zero-potential line of the array substrate is grounded, or the zero-potential line of the array substrate is connected with a zero-potential line of a circuit outside the array substrate.

19. The liquid crystal display device according to claim 18, wherein the zero-potential line of the array substrate is arranged in the corner area of the liquid crystal display device.

20. The liquid crystal display device according to claim 9, wherein the zero-potential line of the array substrate is grounded, or the zero-potential line of the array substrate is connected with a zero-potential line of a circuit outside the array substrate.
